(19) United States
(12) Patent Application Publication
(10) Pub. No.: US 2022/0185580 A1
(43) Pub. Date: Jun. 16, 2022

(54) PERFORATED REFUSE BAG AND RELATED METHODS

(71) Applicant: Naresh Tohan, Fresno, CA (US)

(72) Inventor: Naresh Tohan, Fresno, CA (US)

(21) Appl. No.: 17/118,592

(22) Filed: Dec. 10, 2020

(51) Int. Cl. B65F 1/00; B65D 33/01

(52) U.S. Cl. CPC B65F 1/0006; B65F 2250/1146; B65F 2250/1143; B65D 33/01

(57) ABSTRACT

The present invention relates to an improved perforated refuse bag inoperable of retaining fluids and therefore resistant to conducting a controlled fermentation process within the bag. Embodiments of the present invention provides a plastic bag with perforations of a particular shape, size, and distribution that renders the bag inoperable of retaining liquids but still operable of holding refuse without rupturing. The combination of the bag composition and the particular arrangement of perforations provides a durable low-cost refuse bag operable of supporting a substantial load without rupturing and inoperable of conducting a controlled fermentation process.

### FIELD OF THE INVENTION

The present invention relates to a refuse bag with a plurality of perforations. More particularly, embodiments of the present invention pertain to a perforated refuse bag operable of supporting load and containing a plurality of perforations adapted to prevent fluid retention and therefore prevent a controlled fermentation process within the bag.

### DISCUSSION OF THE BACKGROUND

Fermentation, the process in which a substance is broken down over time by microorganisms, is a necessity for the creation of alcoholic beverages such as wine or beer. Variations of this process using different substances, microorganisms, and techniques have led to the large variety of alcoholic beverages that are enjoyed today. However, since alcoholic fermentation is a relatively simple process, it may be performed utilizing items, such as grapes and trash bags, that are commonly found in areas where alcohol is prohibited, such as prisons or rehabilitation centers. Reports of inmates creating bootlegged alcoholic beverages, often referred to as pruno or prison wine, utilizing common trash bags in which to conduct a fermentation process have become a growing health concern across prisons nationwide. Such alcoholic beverages have already led to an outbreak of botulism in prisons in at least three different states. Thus, there remains a need for a bag resistant to conducting a controlled fermentation process and capable of supporting refuse comparable to a typical bag of similar size and composition.

### SUMMARY OF THE INVENTION

The present invention relates to an improved perforated refuse bag inoperable of retaining fluids and therefore resistant to conducting a controlled fermentation process within the bag. Embodiments of the present invention provides a plastic bag with perforations of a particular shape, size, and distribution that renders the bag inoperable to retain liquids but still operable to hold refuse without rupturing. The combination of the bag composition and the particular arrangement of perforations provides a durable low-cost refuse bag operable to hold and support a substantial load while preventing its use in a fermentation process.

In the present invention, the perforated refuse bag is comprised primarily of plastic material, such as low-density polyethylene, linear low-density polyethylene, medium density polyethylene, polypropylene, or various mixtures thereof. The perforated refuse bag may be available in a variety of shapes and sizes such as rectangular, elliptical, triangular or polygonal or a standard combination thereof with seams that enable to the bag to conform to a to the shape of a garbage receptacle during use. For example, the present invention relates in some embodiments to a refuse bag for insertion into a 3-gallon refuse receptacle. In such embodiments, the dimensions of the bag may have a width of about 15 to about 30 inches and a height of about 10 to about 20 inches, and may have a volume when opened in a range of about 3 to about 4 gallons. The bag may have a rectangular shape with extra patterned material that is bunched in the bottom portion of the bag to allow the bag to opened up to fill the interior of the 3-gallon receptacle when it is deployed. For example, the bag may have material bunched and sealed in a flat seal pattern, a gusset seal pattern, or a star seal pattern.

In further embodiments of the present invention, the refuse bag may be configured to be inserted into a 33-gallon cylindrical garbage receptacle, and may have a generally rectangular shape with a width of about 40 inches and a height of about 50 inches operable of conforming to the cylindrical shape of the receptacle. In some embodiments, the plastic bag has a generally rectangular shape with a width of about 15 inches to 65 inches (e.g., about 24 inches, about 40 inches, about 50 inches, about 61 inches, or any value therein) and a height of about 15 inches to 70 inches (e.g., about 24 inches, about 46 inches, about 50 inches, about 68 inches, or any value therein). The present invention is also operable to carry a substantial load, or a load comparable to a bag of similar size, thickness, and material. Further embodiments of the refuse bag of the present invention are contemplated herein.

In some embodiments, the perforations on the refuse bag are evenly distributed and of the same shape and size. The perforations may have a generally circular shape with each circle having a diameter in the range of about 0.8 cm to about 1.2 cm (e.g., about 0.85 cm, about 1.0 cm, about 1.15 cm, or any value therein). The perforations may be spaced out 1.5 to 2.5 inches horizontally (e.g., about 1.75 inches, about 2 inches, about 2.25 inches, or any value therein) and 2.5 to 3.5 inches vertically (e.g., about 2.75 inches, about 3 inches, about 3.25 inches, or any value therein). Such arrangement of the perforations prevents the bag from being used for a fermenting process or rupturing when it's supporting a substantial load.

In some embodiments, the perforated refuse bag may further comprise a reservoir in the bunched material at the inferior end of the bag and absent of perforations that enable the bag to retain a minimal amount of fluids. The fluid reservoir may comprise the area proximal to the lower edge of the bag and must remain relatively small in order to retain the fermentation resistance properties provided by the perforations. The fluid reservoir may have a radius of about 1 inch to about 6 inches (e.g., about 1.5 inches, about 4 inches, about 3 inches, or any value therein) wherein the radius is measured from the inferior edge, seam, or lowest point of the bag during intended use. While retaining fluid enables a bag to be utilized for fermentation, it's worth noting that the fluid reservoir, as described above, would render the present invention impractical for fermentation for at least two reasons. First, the amount of volume that may be contained in the fluid reservoir is relatively small, leaving little room for fermentation ingredients and an insignificant yield. Secondly, the plurality of perforations on the bag would make it extremely difficult to prevent airborne microbes from spoiling any potential batches.

In some embodiments of the present invention, the perforated refuse bag is comprised of low-cost high-density polyethylene with circular perforations spaced about 2 inches apart horizontally and about 3 inches apart vertically and with each perforation having a diameter of about 1 inch. While any arrangement of perforations would render any bag inoperable of retaining liquids, only the arrangement disclosed in the present invention has been proven, through extensive experimentation, to provide comprehensive resistance to conducting a controlled fermentation process without an increased risk of tearing or rupturing. Thus, it's been determined that the combination of bag composition and the particular perforation arrangement disclosed in the present invention provides a bag that has been optimized for fermentation resistance, rupture resistance, low production cost, and substantial load support. The refuse bags of the present invention may be fabricated with other materials, such as low-density polyethylene, polyethylene, polyethylene resin, thermoplastic resin film,

In some embodiments, the present invention may further comprise notches or seams that are placed in predetermined areas that enable a user to easily grasp or tie the bag. For example, there may be four notches, evenly distributed across the opening of the bag, that enable the bag to be easily gripped for removal from the garbage receptacle. In another embodiment, the rim of the bag opening may comprise a plastic band that may also be utilized to grasp or tie the bag with ease.

In one aspect, the device is a perforated refuse bag with the perforations arranged in a predetermined manner to enable the bag to support a substantial load without rupturing. The perforations may be evenly distributed and have a circular shape with a diameter between the range of about 0.85 cm to about 1.15 cm. Each perforation may be evenly distributed about 1.75 inches to about 2.25 inches horizontally and about 2.75 to 3.25 inches apart vertically. The device may be comprised of low-density polyethylene, linear low-density polyethylene, medium density polyethylene, polypropylene or a mixture thereof.

In another aspect, the present invention is a method for creating a low-cost perforated refuse bag inoperable of retaining fluids and support a substantial load without rupturing by selecting an appropriate bag material and utilizing a hole-punching device to add perforations to the bag in a predetermined manner. The appropriate bag material may be selected from low density polyethylene, linear low-density polyethylene, medium density polyethylene, polypropylene or a mixture thereof. The hole punching device may be an automated machine and may evenly distribute the perforations about 1.75 inches to about 2.25 inches apart horizontally and about 2.75 to about 2.25 inches apart vertically. Each perforation appended onto the bag may have a circular shape with a diameter in between the range of about 0.85 cm to about 1.15 cm.

It is an object of the present invention to provide a perforated refuse bag operable of supporting a substantial load and inoperable of retaining fluids.

It is also an object of the present invention to provide a perforated refuse bag of a particular material with perforations arranged in a particular manner to optimize provide rupture resistance and production cost.

It is also an object of the present invention to provide a perforated refuse bag inoperable of conducting a controlled fermentation process.

### BRIEF DESCRIPTION OF THE DRAWINGS

FIG. 1 provides a perspective view of the perforated refuse bag opened slightly, according to an embodiment of the present invention.

FIG. 2 provides a front view of the perforated refuse bag, according to an embodiment of the present invention.

FIG. 3 provides a back view of the perforated refuse bag, according to an embodiment of the present invention.

FIG. 4 provides a top plan view of the perforated refuse bag, according to an embodiment of the present invention.

FIG. 5 provides a bottom plan view of the perforated refuse bag, according to an embodiment of the present invention.

FIG. 6 provides a left-side view of the perforated refuse bag, according to an embodiment of the present invention.

FIG. 7 provides a right-side view of the perforated refuse bag, according to an embodiment of the present invention.

FIG. 8 provides a view of the perforated refuse bag full of refuse, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

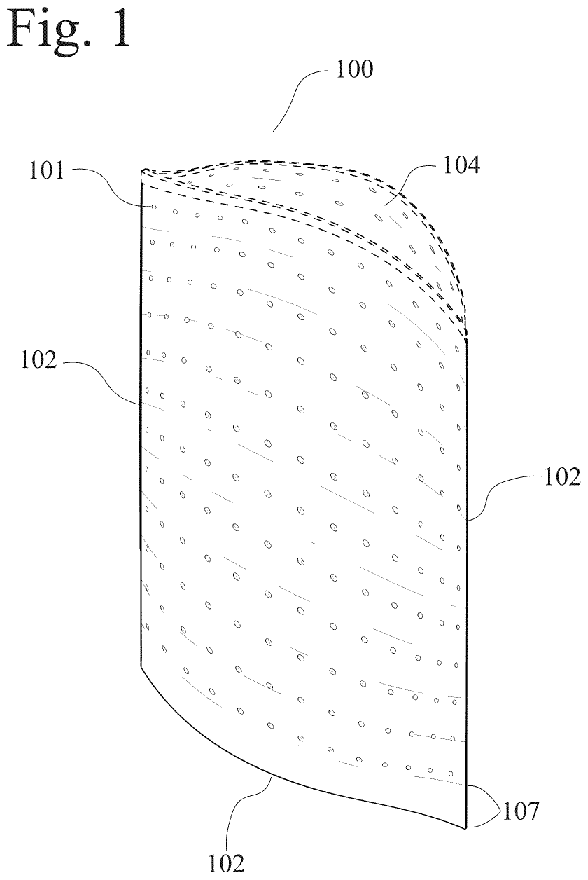

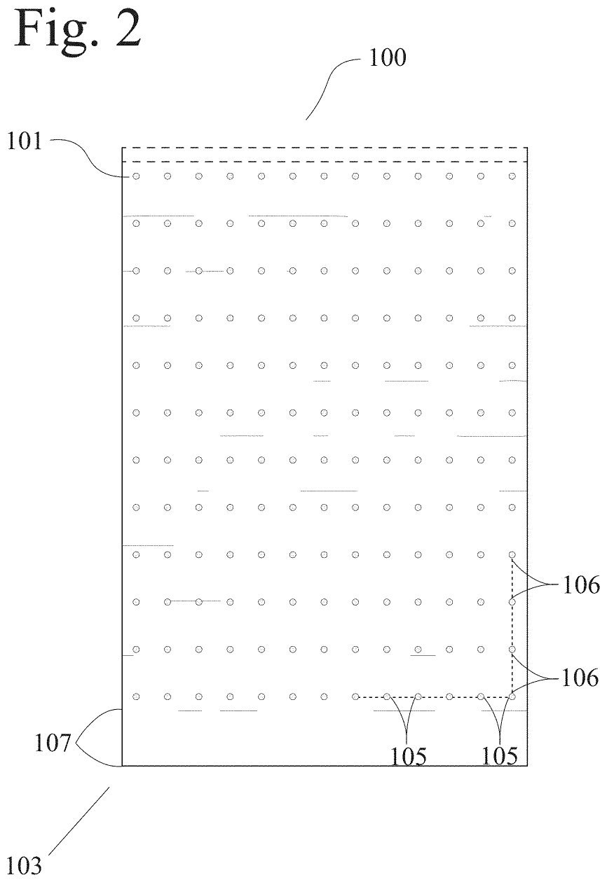

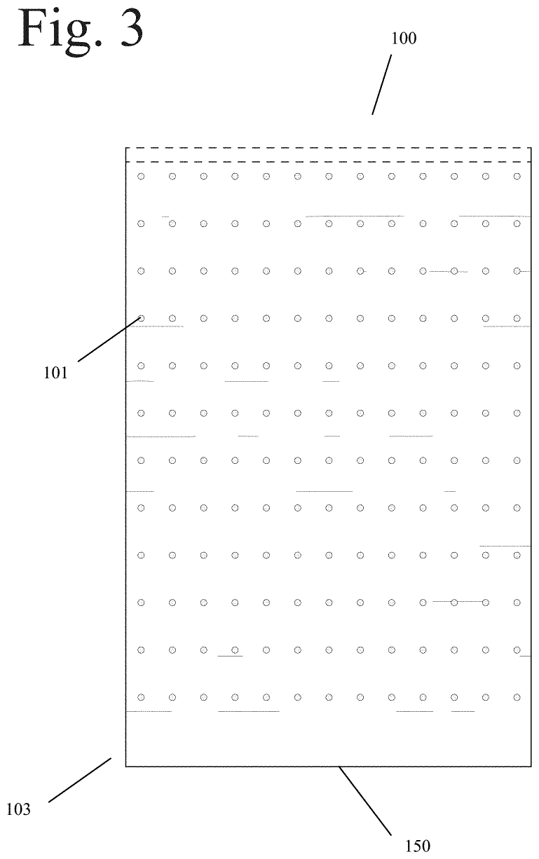

As shown in FIGS. 1-8, the perforated refuse bag 100 is comprised primarily of plastic material, such as low-density polyethylene, linear low-density polyethylene, medium density polyethylene, polypropylene or a mixture thereof. The perforated refuse bag 100 may be available in a variety of shapes and sizes such as rectangular, elliptical, triangular or polygonal or a standard combination thereof with seams 102 that enable to the bag to conform to a to the shape of a garbage receptacle during use and bag opening 104. For example, an embodiment of the present invention intended for a 10-gallon box-shaped garbage receptacle, may have a generally rectangular shape with a width of about 24 inches and a height of about 24 inches operable of conforming to the box-like shape of the receptacle. As shown in FIG. 2, the perforated refuse bag may have a generally rectangular shape 103 with a width in the range of about 15 inches to 65 inches (e.g., about 15-30 inches, about 40 inches, about 50 inches, about 61 inches, or any value therein) and a height in the range of about 15 inches to 70 inches (e.g., about 12 to about 20 inches, about 20 to about 46 inches, about 50 inches, about 68 inches, or any value therein). The present invention is also operable to carry a substantial load, or a load comparable to a bag of similar size, thickness, and material.

As Shown in FIG. 2, the perforations 101 on the refuse bag 100 may be evenly distributed and of the same shape and size. The perforations 101 may have a generally circular shape with each circle having a diameter about 0.8 cm to about less than 1.2 cm (e.g., about 0.85 cm, about 1.0 cm, about 1.15 cm, or any value therein). The perforations 101 may be spaced out 1.5 to 2.5 inches horizontally 105 (e.g., about 1.75 inches, about 2 inches, about 2.25 inches, or any value therein) and 2.5 to 3.5 inches vertically 106 (e.g., about 2.75 inches, about 3 inches, about 3.25 inches, or any value therein). Such arrangement of the perforations prevents the bag 100 from being used for a fermenting process or rupturing when it's supporting a substantial load.

In some embodiments, as shown in FIGS. 1-3, the perforated refuse bag may further comprise a reservoir located at the inferior end of the bag and absent of perforations that enable the bag to retain a minimal amount of fluids. The fluid reservoir 107 may comprise the area proximal to the lower edge of the bag and must remain relatively small in order to retain the fermentation resistance properties provided by the perforations. The fluid reservoir 107 may have a radius of about 1 inch to about 3 inches (e.g., about 1.5 inches, about 2 inches, about 3.5 inches, or any value therein) wherein the radius is measured from the inferior edge, seam, or lowest point of the bag during intended use. While retaining fluid enables a bag to be utilized for fermentation, it's worth noting that the fluid reservoir 107, as described above, would render the present invention impractical for fermentation.

The refuse bag 100 may have a rectangular shape with extra patterned material 150 that is bunched in the bottom portion of the bag 100 to allow the bag to opened up to fill the interior of the receptacle when it is deployed. For example, the bag 100 may have material 150 bunched and sealed in a flat seal pattern, a gusset seal pattern, or a star seal pattern.

In some embodiments, as shown in FIGS. 2-3 and 8, the perforated refuse bag 100 is comprised of low-cost high-density polyethylene with circular perforations 101 spaced about 2 inches apart horizontally 105 and about 3 inches apart vertically 106 and with each perforation 101 having a diameter of about 1 inch. While any arrangement of perforations 101 would render any bag inoperable of retaining liquids, only the arrangement disclosed in the present invention has been proven, through extensive experimentation, to provide comprehensive resistance to conducting a controlled fermentation process without an increased risk of tearing or rupturing. Thus, it's been determined that the combination of bag composition and the particular perforation arrangement disclosed in the present invention provides a bag that has been optimized for fermentation resistance, rupture resistance, low production cost, and substantial load support.

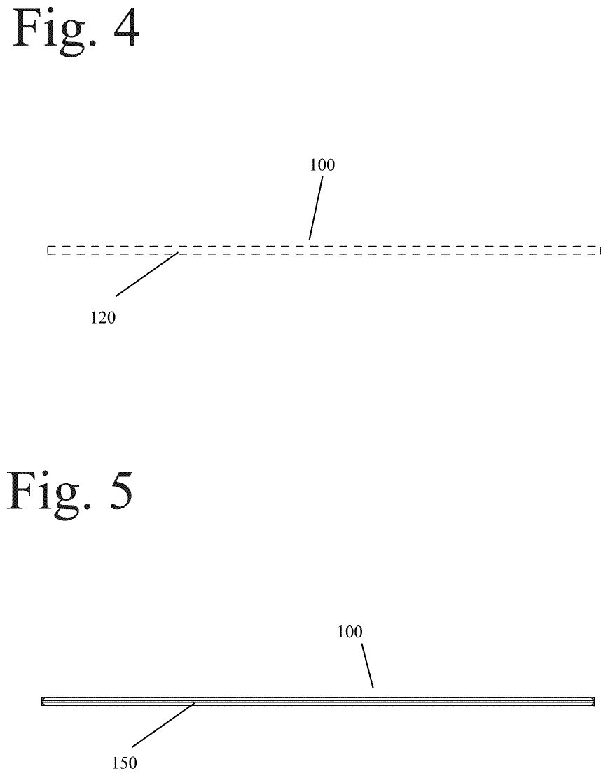

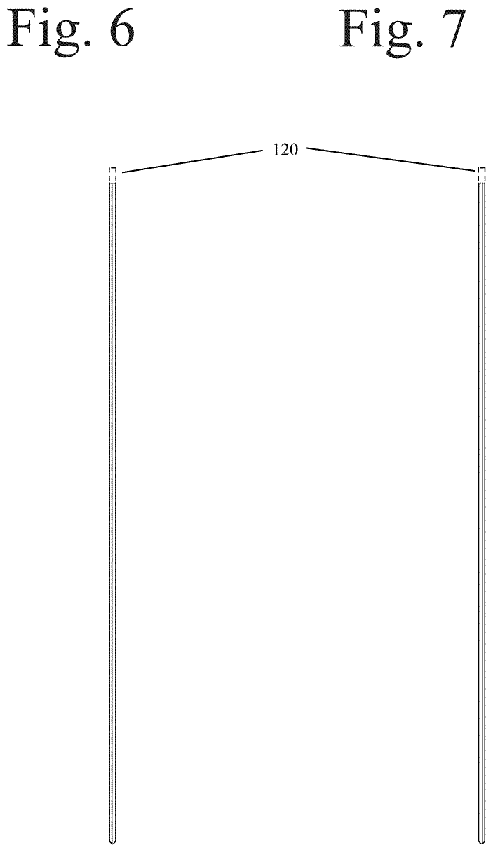

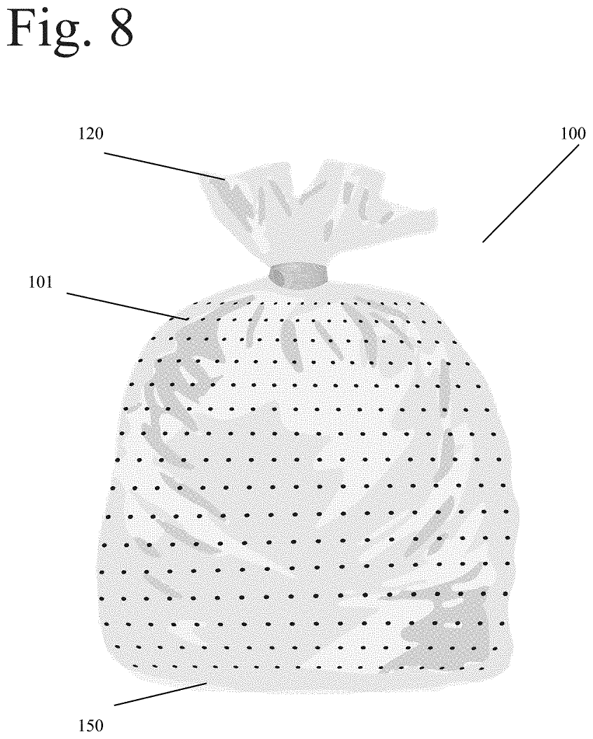

FIG. 4 provides a top view of the bag 100, showing the upper opening 120. FIG. 5 provides a bottom view of the bag 100 (flattened and undeployed), with the bunched bottom section 150 of the bag 100. FIGS. 6 and 7 show each side of the bag 100 in a flattened undeployed condition. FIG. 8 shows the refuse bag 100 in a deployed and filled condition with the bag expanded into roughly round shape. In the filled condition, the bottom section 150 is expanded into a small, shallow reservoir that can retain small amounts of moisture that may accumulate from refuse deposited in the refuse bag 100. However, the volume of the bottom section 150 is insufficient to allow for a fermentation process in the trash bag 100.

The present invention also relates to a method for creating a low-cost perforated refuse bag 100 inoperable of retaining fluids and support a substantial load without rupturing by selecting an appropriate bag material and utilizing a hole-punching device to add perforations 101 to the bag in a predetermined manner. The appropriate bag material may be selected from low density polyethylene, linear low-density polyethylene, medium density polyethylene, polypropylene or a mixture thereof. The hole punching device may be an automated machine and may evenly distribute the perforations 101 about 1.75 inches to 2.25 inches apart horizontally 105 and about 2.75 to about 2.25 inches apart vertically 106. Each perforation appended onto the bag may have a circular shape with a diameter in between the range of about 0.85 cm to about 1.15 cm.

It should be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, and to thereby enable others skilled in the art to best utilize the invention and various embodiments with various modifications as are suited to the particular use contemplated.

1. A perforated refuse bag inoperable of retaining fluids wherein the perforations are arranged in a predetermined manner that enable the perforated refuse bag to support a substantial load without rupturing.

2. The device of claim 1, wherein said perforations are evenly distributed and each have a circular shape with a diameter in the range of about 0.85 cm to about 1.15 cm.

3. The device of claim 2, wherein said perforations have a diameter in the range of about 0.95 cm to about 1.05 cm.

4. The device of claim 2, wherein said perforations have a diameter of about 1 cm.

5. The device of claim 2, wherein said perforations are each evenly distributed about 1.75 to about 2.25 inches apart horizontally and 2.75 to 3.25 inches apart vertically.

6. The device of claim 2, wherein said perforations are each evenly distributed about 1.95 to about 2.05 inches apart horizontally and 2.9 to 3.1 inches apart vertically.

7. The device of claim 2, wherein said perforations are each evenly distributed about 2 inches apart horizontally and 3 inches apart vertically.

8. The device of claim 5, wherein said perforated refuse bag further comprises a fluid reservoir located on the area proximal to the inferior edge of said perforated refuse bag, lacking said perforations, and operable of retaining waste.

9. The device of claim 8, wherein said fluid reservoir has a radius of about 1 inch to about 3 inches wherein the radius is measured from the inferior edge, seam, or lowest point of said perforated refuse bag.

10. The device of claim 5, wherein said perforated refuse bag is comprised of low density polyethylene, linear low density polyethylene, medium density polyethylene, polypropylene or a mixture thereof.

11. The device of claim 5, wherein said perforated refuse bag is comprised of high density polyethylene.

12. The device of claim 11, wherein the combination of high density polyethylene that comprises said refuse bag and arrangement of perforations provides a perforated refuse bag optimized for fermentation resistance, rupture resistance, low production cost, and substantial load support.

13. The device of claim 12, wherein said substantial load is a load comparable to that of which a standard non-perforated bag of similar composition, thickness, and size can support.

14. A method of creating a low-cost perforated refuse bag inoperable of retaining fluids and support a substantial load without rupturing comprising selecting the appropriate bag material and utilizing a hole-punching device to add perforations to the bag in a predetermined manner

15. The method of claim 14, wherein said appropriate bag material is low density polyethylene, linear low density polyethylene, medium density polyethylene, polypropylene or a mixture thereof.

16. The method of claim 14, wherein said appropriate bag material is comprised of high density polyethylene.

17. The method of claim 16, wherein said perforations are evenly distributed and each have a circular shape with a diameter in the range of about 0.85 cm to about 1.15 cm.

18. The method of claim 17, wherein said perforations have a diameter of about 1 cm.

19. The method of claim 17, wherein said perforations are each evenly distributed about 1.75 to about 2.25 inches apart horizontally and 2.75 to 3.25 inches apart vertically.

20. The method of claim 17, wherein said perforations are each evenly distributed about 2 inches apart horizontally and 3 inches apart vertically.

21. (canceled)

22. (canceled)

23. (canceled)

24. (canceled)
